(19) United States
(12) Patent Application Publication
(10) Pub. No.: US 2009/0265287 A1
(43) Pub. Date: Oct. 22, 2009

(54) Adaptive Programmable Template Matching System

(76) Inventor: Alfred M. Haas, Hyattsville, MD (US)

Correspondence Address: Alfred M. Haas, 3410 Tulane Drive, Apt. 31, Hyattsville, MD, 20783, US

(21) Appl. No.: 12/422,964

(22) Filed: Apr. 13, 2009

Related U.S. Application Data
(60) Provisional application No. 61/044,284, filed on Apr. 11, 2008.

(51) Int. Cl. G06N 5/00; G06N 3/06; G06F 15/18

(52) U.S. Cl. 706/3; 706/20; 706/14

(57) ABSTRACT

This invention pertains to adaptive programmable template matching systems. One or more templates are stored, either directly by a user, or by an unsupervised programming method, onto programmable memories, and in one mode of operation, the distance between a signal and the template is computed using a distance estimation circuit. The output of the distance estimator provides a metric for the proximity of the signal to the template, and an adaptive or user-defined threshold may be set for identifying matches. Various applications for this invention are disclosed, including implantable neural spike sorting chips, template matching image sensors, and template matching bio-sensors, for example DNA or antibody sensing.

### CROSS-REFERENCE TO RELATED APPLICATIONS

Pursuant to 35 USC § 119(e) and as set forth in the Application Data Sheet, this utility application claims the benefit of priority from U.S. Provisional Patent Application No. 61/044,284 (“the '284 provisional”), which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Template matching refers generally to methods of comparing a signal with one or more templates and identifying the closest match between the signal and one or more of these templates. Template matching systems are used as pattern recognition systems for such applications as fingerprint and retinal identification, medical image registration and diagnosis, and spike sorting algorithms, to name a few.

Platforms for cell-based biosensing typically record and amplify localized time-varying extracellular potentials, but perform limited additional signal processing on-chip. State-of-the-art neural implants fare little better: although microelectrode arrays have been chronically implanted into the cortex, many such “implants” are essentially just wires, onto which low-resolution, high-power application specific integrated circuits (“ASICS”) have been mounted, or mixed-signal threshold detectors that are incapable of discriminating between spikes from neighboring neurons. Each of these systems suffers the same general deficiency—they cannot encode the vast amount of incident neural data.

Moreover, although cultured cells may be able to endure the heat generated by clocked digital processors, neurons in situ cannot. As a result, neural implants continue to rely on hard-wired connections between microelectrode and PC that pierce the skull and can succumb to noise, corrosion, signal attenuation, and infection. Thus it would be advantageous to have low-power circuits capable of detecting and encoding neural data for low-power RF transcutaneous transmission (or additional on-chip processing for control, etc.), and thereby enabling a new generation of implantable cognitive and cortically controlled neural prosthetics. Such prosthetics could be implemented to restore lost or impaired vision, hearing, and motor control, among other possibilities.

Despite advancements in the field, it remains impossible to measure individual neural electrical signals non-invasively. Thus, neural prosthetics that would seek to ascertain the state of the system prefer a direct brain-machine interface; it is desired to record directly from, or in close proximity to the nerve cells of interest. Further, in order to conserve the signal strength of the extracellular potentials measured, which are typically on the order of 50 uV peak-to-peak, and to mitigate against noise corruption along transmission lines, the required recording electrodes should be connected as closely as possible with the hardware that will sort the incident spikes. To maximize SNR and mitigate against external interference, implantable signal processing architectures are therefore preferred.

Totally implantable neural prosthetics suitable for the rehabilitation of victims of stroke, spinal cord injury and neural degenerative diseases such as ALS preferably meet stringent power requirements while simultaneously servicing a sufficiently large population of neurons to be capable of restoring lost functionality. Owing primarily to power-density constraints, even the most advanced existing prosthetic devices operate under severe bandwidth limitations, requiring either: (a) that the true prosthetic be external to the brain—i.e., only microwires are implanted; (b) that the prosthetic be restricted to only a single channel or two; or (c) that the prosthetic sacrifice resolution or classification capability to enable detection across many channels at once. As a result, such systems require additional external hardware to complete the spike sorting task and make sense of information from a population of neurons in real-time. Moreover, chronically implanted prosthetics typically use hard-wired connections that pierce the skull and are susceptible to noise, corrosion, signal attenuation, and infection. To truly restore lost sensory, cognitive and motor function to victims of debilitating neural injury or disease, a fully implantable neural prosthetic capable of reliably detecting and classifying spikes from 10′s to 100′s of channels in real-time is preferred.

There have been many reported techniques, algorithms, software and circuits for the detection and classification of neural action potentials. Many of the algorithms report the ability to detect and resolve spikes with a theoretical accuracy approaching 100% when operating at or very near 0 dB signal-to-noise (“SNR”) ratios. However, as Yang and Shamma observed, “the overriding goal of the spike detection algorithm to be used with multielectrode arrays is not so much to detect the smallest spikes in the midst of noisy traces, but rather to isolate the most reliable spikes with no or minimal human intervention.” This applies equally to implantable neural prosthetics—it is desirable to extract the minimum relevant information from the vast array of incident neural data; this preferably means identifying reliable spikes without operator supervision. Extracting reliable spikes, in turn, means reliable classification, and thus more robust implantable architectures. Furthermore, because there is greater confidence in assigning meaning to a population code when the population is large, it is desirable for spike sorting applications seek to increase recording and stimulation channel density to the extent practically possible.

There are a number of papers which disclose circuits for spike sorting—these are disclosed in U.S. Provisional Patent Application No. 61/044,284, from which this application claims priority. By way of comparison, none of these systems are template matching systems, and none implement programmable templates.

In addition to planar microelectrode arrays disclosed in the '284 provisional, sharp electrode arrays (“sharps”) such as the Utah array described in C. T. Nordhausen, E. M. Maynard, and R. A. Normann, “Single unit recording capabilities of a 100-microelectrode array,” Brain Res., vol. 726, pp. 129-140, 1996, and Harrison, R. R., Watkins, P. T., Kier, R. J., Lovejoy, R. O., Black, D. J., Greger, B., Solzbacher, F., “A Low-Power Integrated Circuit for a Wireless 100-Electrode Neural Recording System,” IEEE Journal of Solid-State Circuits, vol. 42, January 2007, pp. 123-133, are often used for neural recording. U.S. Pat. No. 6,993,392 discloses a high-density multi-channel microwire electrode array for implementing a brain machine interface. U.S. Pat. No. 7,187,968 discloses an electrode array and associated circuitry for neural spike detection. U.S. Pat. No. 7,209,788 discloses a brain machine interface including an implantable electrode array.

Nanoscale memory systems, such as those disclosed in U.S. Pat. Nos. 7,330,369 and 7,489,537 can be integrated with nano, micro or other sized electrodes. Although one of skill in the art would appreciate that electrode arrays fabricated using mature commercial integrated CMOS processes, or conventional microscale fabrication techniques like those used to create the Utah array, typically provide higher functional yield and better matched elements than first generation nano-electrode processes, one of skill in the art would also appreciate that nanoscale memory systems potentially offer an advantage of denser integrability, so long as it is possible to compensate for relatively low nano-device yield, and relatively high mismatch and process variability.

In view of the foregoing, there exists a need for compact, densely integrated (The phrase “densely integrated” is defined broadly in this application to mean densely spatially integrated, as for example an integrated circuit or other micro- or nano-array may be densely integrated. The phrase “densely integrated” is specifically not intended to be construed as limited to integrated circuits—it also describes other micro- or nano-electrode arrays, polymer electrode arrays, CNT arrays, etc.) programmable template matching systems for encoding electrical signals generated by biological, chemical and other sensors, as well as electrical signals from electrode arrays.

There is also a general need to reduce the size, power consumption and design complexity of programmable template matching systems to the extent possible in order to increase the density of arrays of such systems; to permit operation in environments where excessive heat dissipation or other EM radiation from, e.g., rapid circuit switching operations, is unacceptable, for example in neural implants; to extend battery-powered system lifetimes; to reduce overall costs; and for other reasons understood by those of skill in the art.

The text by J. Baker, “CMOS Circuit Design, Layout and Simulation,” 2d Edition, Copyright 2005, Institute for Electrical and Electronics Engineers, Inc. (“IEEE”), and published by the IEEE and Wiley-Interscience (“the Baker text”) discloses fundamentals of integrated CMOS circuit design at the level of an undergraduate university course. In addition, the text “Floating Gate Devices: Operation and Compact Modeling” by P. Pavan, L. Larcher, and A. Marmiroli, Copyright 2004, Kluwer Academic Publishers, Inc., (“the FG text”) discloses information about the physics and general operation of floating gate devices. As one clarification, in this specification, we define memories broadly to include floating gate devices, but also according to the plain and ordinary meaning of the word to include other analog memory devices, for example memristors, chalcogenides, organic and inorganic polymers, and CNTs.

The discussion of the background of the invention herein is included to explain the context of the invention. Although each of the patents and publications cited herein are hereby incorporated by reference, neither the discussion of the background nor the incorporation by reference is to be taken as an admission that any of the material referred to was published, known, or part of the common general knowledge as at the priority date of any of the claims.

### BRIEF SUMMARY OF THE INVENTION

The invention disclosed herein comprises adaptive programmable template matching systems and methods of operating these systems. Programmable memories store the templates, and in one mode of operation, the distance between a signal and one or more templates is computed using a distance estimation circuit. The output of the distance estimator provides a metric for the proximity of the signal to the template, and an adaptive or user-defined threshold may be set for identifying matches.

### BRIEF DESCRIPTION OF THE SEVERAL VIEWS OF THE DRAWING

FIG. 1 is a block diagram of a programmable template matching system in accordance with one embodiment of the present invention.

### DETAILED DESCRIPTION OF THE INVENTION

This application is directed broadly to adaptive programmable template matching hardware. In one specific embodiment, disclosed in greater detail in U.S. Provisional Application No. 61/044,284, the programmable template matching hardware is implemented in a complementary metal oxide semiconductor (“CMOS”) process and comprises one or more programmable hardware templates, circuits for comparing an incoming signal to one or more of the templates stored in memory of the programmable hardware templates, and a distance estimator for evaluating the quality of the template match, with optional additional control and readout circuitry. Templates be programmed or learned on-chip with or without user control.

The distance estimator may be a Euclidean, mean, least-squares, or other known algorithm for establishing the correlation between two signals; circuit realizations of each of the explicitly named estimators and many more not expressly named are known to those of skill in the art. The circuits of the instant invention may be implemented in CMOS, BiCMOS or other integrated processes, may comprise analog, digital or mixed-signal circuits, may be implemented using a microcontroller, a programmable integrated circuit (“PIC”), an FPGA's and/or in other hardware known to those of skill in the art, and may operate asynchronously, or be clocked.

Programming may be performed with or without user supervision. In the case of unsupervised learning, additional circuits are employed to trigger the learning mechanism and to regulate the programming. These mechanisms include, but are not limited to, a circuit for detecting action potentials or spikes and triggering learning based these detections, and for regulating learning by turning off the programming in the absence of such detections. Programming of floating gates may be accomplished by modulating the voltage at different nodes of the transistor(s) connected to the floating gate, including drain, source and control gate modulation, as well as indirect programming using one or more additional transistors whose gates are coupled to the floating gate.

More generally, the circuits that comprise the adaptive programmable template matching system may be current or voltage mode, and may implement a temporal or spatial decomposition of a signal using arbitrary gain and bandwidth filter elements that may be cascaded in sequence or parallel. Likewise, the template may be stored on floating gates, latches, flip-flops, capacitors, MOScaps, or any other form of electrical, magnetic, optical, organic or inorganic memory, and may be programmed using any means appropriate to the storage medium, including but not limited to, hot electron injection, Fowler-Nordheim tunneling, UV-light, electrical voltage, current or charge, EM radiation, chemical promoters or transcription factors, etc.

One embodiment of the adaptive programmable template matching system is disclosed in U.S. Provisional Patent Application No. 61/044,284, and in the publication by A. Haas, et al., “Real Time Variance Based Template Matching Spike Sorting System,” IEEE/NIH Life Science Systems and Applications Workshop, 2007, pp. 104-107. In that publication, we disclosed a real-time variance based template matching system for spike sorting. The system employs an ultra-low-power CMOS variance estimator to detect and discriminate between distinct spike classes in real-time. As fabricated in a commercial 0.5 μm process, that specific embodiment of the variance estimation circuit has a footprint of less than 0.16 mm², a power consumption of less than 10 nW in typical operation for spike sorting, and scales linearly with the number of inputs.

In one embodiment where the distance estimator is a variance estimation circuit, detection of neural events may be accomplished in one of two ways, either: (a) by a template match, corresponding with a local variance minimum, as an incoming neural signal is convolved with one or more templates in parallel; or (b) by employing the variance estimator as an energy operator whose maximum output corresponds with a neural spike. Local minima and maxima may be identified using a low-power current comparator or peak detector. Classification may similarly be accomplished using the variance estimator to compute the distance between a signal and one or more distinct templates (which may optionally form an orthornormal basis that span the signal space). As an incident waveform is convolved with a stored template, a continuous time estimate of the distance between the signal and the template is computed,

The template may be an inverted, normalized, N-point version of an idealized action potential, or any other desired waveform. In one hardware implementation, the template is stored on programmable memories and a filter decomposes an incoming signal using a delay line and employs template matching circuitry to generate N continuous-time outputs which represent the point-wise distance of the neural waveform from the stored template.

In one embodiment, the distance estimator of the present invention comprises variance estimation circuits for computing E[(X−E[X])²]=E[X²]−E²[X], where E[X]=is the expected value, or mean, of a random variable, X. In the case where X is discrete, E[X] is the sample mean. In the specific embodiment disclosed in '284 provisional in the unpublished manuscript, “Real-time current-mode variance estimation circuit,” the circuit computes the variance across N=8 inputs by: (a) copying N=8 input currents, I₀ . . . I₇; (b) individually squaring and then averaging one set of currents to generate E[I²]; (c) averaging and then squaring the average of the second set of currents, to compute E²[I]; and then (d) subtracting the second result from the first. This circuit has been fabricated and characterized as disclosed in the '284 provisional.

It is equally possible to compute variance using voltage-mode circuits, with voltage inputs and voltage outputs. In particular, any of a variety of amplifiers or multipliers known to those of skill in the art is capable of squaring voltages, and subtracting one voltage from another may be accomplished using any one of a number of techniques or circuits known to those of skill in the art, including subtracting operational amplifiers. Methods of computing the mean of a number of voltages is also well known to those of skill in the art.

In one embodiment of the present invention, the variance estimation circuitry may be used to set the variance of a Gaussian generated by any number of circuits known to those of skill in the art, including bump circuits and others disclosed in the '284 provisional.

Memory elements may be analog or digital, volatile or non-volatile, and may be reconfigurable, or reprogrammed only a limited number of times, or zero times. In one configuration, the memory elements are analog floating gates onto which arbitrary voltages (within a range set by the size and geometry of the memory element, the physical limits imposed by the process in which it was fabricated, and the operating voltages of any other electrical circuits which may be integrated with the memory element) which can be computed by one of skill in the art may be stored. Many other memory elements are known and may be incorporated into embodiments of this invention, including but not limited to: digital flip-flops and latches, integrated or discrete capacitors and MOScaps, magnetic, optical, organic, or biological storage media. More specific examples of technologies and devices that may comprise non-volatile analog memories known to those of skill in the art are memristors, chalcogenides, carbon nanotubes, and organic or inorganic polymers.

In the case of analog floating gate memories, programming may be accomplished by some combination of electron injection, tunneling, and/or exposure to UV light. In the case of memristors, programming may be accomplished by passing electric currents through the memristor. Chalcogenide analog memories may be programmed using applied electric potentials, or voltages, across the memory element. CNT and polymer memories may be programmed in ways known to those of skill in the art.

The adaptive programmable template matching systems of the present invention may be physically and/or electrically connected to other circuits, including but not limited to integrated active pixel sensors, CCDs, avalanche photodiodes, electrodes, amplifiers, and other circuits known to those of skill in the art. More particularly, the adaptive programmable template matching systems of the present invention can operate on any electrical signal; the systems of the present invention may be integrated with optical, chemical, biological, electrical, temperature and other physical sensors known to those of skill in the art, for adaptive programmable pattern matching of electrical signals generated by such sensors. Further, the adaptive programmable template matching systems may be integrated with additional processing elements including, but not limited to CMOS or BiCMOS amplifiers, comparators or other integrated circuits, discrete components such as capacitors, digital computers, microcontrollers, programmable integrated circuits (“PIC”), field-programmable-gate-arrays (“FPGA's”), organic circuits such as carbon nanotube networks, DNA or bacterial networks, organic polymer or other circuits.

Other embodiments of the invention integrate programmable template matching circuitry with three-dimensional electrode arrays such as the Utah array, with metal or metal alloy micro- or nano-wire electrode arrays, with substantially planar micro- or nano-electrode arrays, with conductive polymer electrode arrays, and with carbon nano-tube electrode arrays according to the instant invention. These electrodes may be exposed to the environment directly, or may be post processed with a conducting and/or corrosion resistant material, such as gold or platinum black. Metals and alloys and composites can be deposited, or plated in a controlled fashion onto the exposed portion of one or more of the electrodes, so that the electrode could be made corrosion resistant and bio-compatible.

When implemented in conjunction with densely populated microelectrode arrays and low noise bioamplifiers for monitoring the neural activity of cultured cells, such circuits can provide a robust platform for low-false-positive electrophysiological cell-based sensing. In this context, small footprint and integrability are the key constraints—size and power efficiency matters. For example, embodiments of the invention comprising analog circuits can take advantage of the efficiencies of real time analog signal processing and obviate the need for, e.g., analog-to-digital conversions and vast digital memory stores; such systems may be implemented at a fraction of the size and corresponding power cost of comparably performing DSPs.

Using techniques known to those of skill in the art, it is possible to functionalize one or more exposed surfaces of an electrode or array of electrodes that has been integrated with the programmable template matching system of the instant invention. Such functionalization includes but is not limited to organic or inorganic material, such as linker molecules, DNA oligomers, antibodies, and many other substances known to those of skill in the art. This would permit DNA template matching sensors, antibody template matching sensors, and other biochemical sensors where electrical signatures of certain binding or reaction events could be stored in memories. Likewise, any electrodes may be coated with an insulation layer and it is similarly possible to functionalize the insulation layer that coats the electrodes.

As another specific example, disclosed in U.S. Provisional Patent Application No. 61/044,284, olfactory nerve cells are known to respond to different stimuli with different electrophysiological signatures. By culturing such cells atop a packaged electrode array whose outputs were encoded by a one of the proposed template matching circuits, it would be possible to detect changes in the neural signatures by detecting and observing the incident action potential frequencies. There are numerous simple VLSI designs which can convert spike frequency to voltage, known to those of skill in the art, and placing one of these circuits on-chip would enable a frequency thresholding mechanism to trip an alarm whenever the cells became overly excited or compromised. In addition to the simple sensor scheme outline above, other more sophisticated decoding algorithms may be envisioned, giving rise to a wide range of cell-based sensor architectures using the disclosed circuit designs.

For example, as disclosed in the '284 provisional, optical image sensor arrays are ubiquitous. By integrating programmable hardware templates with such sensor arrays, it is possible to perform template matching on spatial or temporal patterns of electrical signals corresponding with patterns of incident light transduced by an optical sensor array. Active pixel sensors, avalanche photodiode arrays, and CCDs are some of the types of light transduction element which may be integrated with the template matching circuitry of the instant invention. Such integrated imaging and template matching systems could provide a new and powerful clinical tool for researchers.

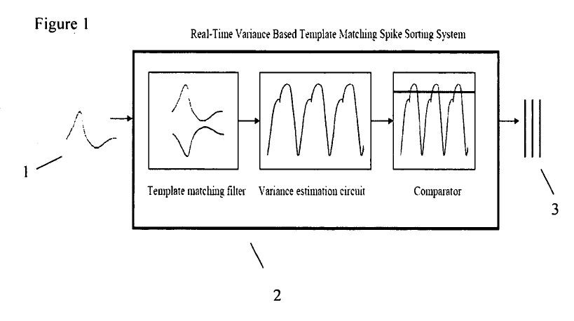

Although it is not believed that drawings are necessary for the understanding of the subject matter sought to be patented, for illustrative purposes we have included a single figure of a specific, but not preferred, embodiment of the disclosed invention. FIG. 1 is a block diagram of a programmable template matching system in accordance with one embodiment of the present invention. In FIG. 1, (1) represents a schematic cartoon of an input signal, (2) represents a block diagram of one embodiment of a programmable template matching system comprising a programmable hardware template (“template matching filter”), a variance estimation circuit and a thresholding (“comparator”); (3) represents an schematic cartoon of an output signal.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A programmable template matching system comprising at least one programmable hardware template and at least one distance estimator;

2. The programmable template matching system of claim 1, wherein the programmable hardware template comprises memory elements for storing values of a template;

3. The programmable template matching system of claim 2, further comprising a programmable analog delay line;

4. The programmable template matching system of claim 3, wherein the programmable analog delay line comprises a cascade of unity gain buffer stages, each unity gain buffer stage having one or more inputs and one or more outputs, at least one of the outputs of each unity gain buffer stage except the output of a last stage being electrically connected to one or more inputs of a next unity gain buffer stage in the analog delay line;

5. The programmable template matching system of claim 4, wherein one or more of the unity gain buffer stages comprises an amplifier in unity gain configuration, said amplifier comprising at least one gain stage;

6. The programmable template matching system of claim 5, wherein the amplifier has programmable gain;

7. The programmable template matching system of claim 5, wherein the amplifier comprises an operational transconductance amplifier;

8. The programmable template matching system of claim 3, wherein the programmable analog delay line comprises a cascade of programmable analog all-pass filters;

9. The programmable template matching system of claim 3 wherein the delay of each element of the analog delay line is programmable;

10. The programmable template matching system of claim 2, wherein the memory elements comprise non-volatile analog memories;

11. The programmable template matching system of claim 10, wherein the non-volatile analog memories comprise floating gates;

12. The programmable template matching system of claim 2, wherein the memory elements comprise digital memories;

13. The programmable template matching system of claim 2, further comprising template matching circuits each having at least two inputs and one output, and a filter bank with at least one input and at least two outputs, at least one of the inputs of each of said template matching circuits being electrically connected to at least one of the outputs of the filter bank, and at least one of the inputs of each of said template matching circuits being electrically connected to at least one of the memories, said outputs of said template matching circuits being proportional to a weighted combination of the signals asserted on its inputs, said non-volatile analog memory having electrical connections to programming circuitry, and said outputs of said template matching circuits being electrically connected to a distance estimator for computing the closeness of a signal asserted at the input of the filter bank to a template stored in the memories.

14. The programmable template matching system of claim 1, wherein the distance estimator comprises a variance estimation circuit having at least one input and one output;

15. The programmable template matching system of claim 14, wherein the variance estimation circuit has a number of inputs, N, and computes the variance of the values of the signals asserted on these N inputs;

16. The programmable template matching system of claim 14, wherein the signals asserted on the input(s) to the variance estimation circuit are electrical currents and the output of the variance estimation circuit is a current;

17. The programmable template matching system of claim 14, wherein the signals asserted on the input(s) to the variance estimation circuit are electrical voltages and the output of the variance estimation circuit is a voltage;

18. The programmable template matching system of claim 14, wherein the variance estimation circuit operates asynchronously;

19. A method of programming the non-volatile analog floating gate memories of claim 11, comprising comparing a first electrical signal with a second electrical signal and asserting a tunneling voltage at the source, drain and bulk of a tunneling MOS transistor whose gate is connected to the floating gate memory if the magnitude of the first signal is greater than the second, and asserting an injection voltage at the drain of a PMOS transistor whose gate is connected to the floating gate memory if the magnitude of the second signal is greater than the first.

20. A programmable template matching system comprising at least one programmable hardware template having at least one memory element, at least one sensor for transducing light into electrical signals, and template matching circuitry for correlating said electrical signals with one or more templates stored in the memory element(s) of at least one programmable hardware template.
